(19) United States
(12) Patent Application Publication
(10) Pub. No.: US 2023/0066321 A1
(43) Pub. Date: Mar. 2, 2023

(54) AUTONOMOUS VEHICLE, CONTROL SYSTEM FOR REMOTELY CONTROLLING THE SAME, AND METHOD THEREOF

(71) Applicants: Hyundai Motor Company, Seoul (KR); Kia Corporation, Seoul (KR)

(72) Inventors: Kyeong Eun Kim, Gunpo (KR); Kyung Joo Bang, Seoul (KR); Il Hwan Kim, Hwaseong (KR); Dong Hyuk Kim, Hanam (KR); Jeong Ki Hong, Seongnam (KR)

(21) Appl. No.: 17/850,492

(22) Filed: Jun. 27, 2022

(30) Foreign Application Priority Data
Aug. 26, 2021 (KR) 10-2021-0113332

(51) Int. Cl. G05D 1/00; G06Q 10/02; G06Q 50/30

(52) U.S. Cl. CPC G05D 1/0011; G06Q 10/02; G06Q 50/30

(57) ABSTRACT

Disclosed are an autonomous vehicle, a control system for remotely controlling the same, and a method thereof. Provided is an autonomous vehicle, including an autonomous driving control apparatus. The control apparatus is configured to include a processor. The processor is configured to generate a candidate path group to a destination, request a remote driving reservation to the control system when an autonomous driving section and a section requiring remote control are included in the candidate path group, receive a path selected from the candidate path group by a user depending on availability of a remote driving reservation of the control system and estimated fare, control the vehicle to follow the selected path, and control the vehicle depending on remote control of the control system when the vehicle reaches the section requiring remote control. The control apparatus is further configured to include a communication device configured to communicate with the control system.

### CROSS-REFERENCE TO RELATED APPLICATION

This application is based on and claims benefits of Korean Patent Application No. 10-2021-0113332, filed in the Korean Intellectual Property Office on Aug. 26, 2021, the entire contents of which are incorporated herein by reference.

### TECHNICAL FIELD

Embodiments of the present disclosure relate to an autonomous vehicle, a control system for remotely controlling the same, and a method thereof, and more particularly, to a technique for generating or changing a path of an autonomous vehicle by checking whether remote driving is possible at a specific time.

### BACKGROUND

As an electronic technique of a vehicle develops, an interest in an autonomous vehicle that drives to a destination by recognizing a driving environment of the vehicle itself without manipulation of a user has been growing.

An autonomous vehicle refers to a vehicle capable of operating by itself without manipulation of a user or a passenger.

While driving in an autonomous driving mode, there may be a situation in which it is impossible to follow a driving path to the destination normally although there is no abnormality in a function of the vehicle. As such, when a situation where it is impossible to follow a path occurs during autonomous driving, it is often difficult to follow the driving path, such as when the user directly intervenes in control of the vehicle or when the user's intervention is difficult, the vehicle stops.

### SUMMARY

An exemplary embodiment of the present disclosure has been made in an effort to provide an autonomous vehicle, a control system for remotely controlling the same, and a method thereof, in which remote control is performed by the control system at start of driving in a section requiring remote control after driving in an autonomous driving control section, and autonomous driving control is performed again at end of the section requiring remote control by making a reservation by determining whether it is possible to reserve the section requiring remote control when generating a path including the autonomous driving control section and the section requiring remote control.

The technical objects of embodiments of the present disclosure are not limited to the objects mentioned above, and other technical objects not mentioned can be clearly understood by those skilled in the art from the description of the claims.

An exemplary embodiment of the present disclosure provides an autonomous vehicle, including an autonomous driving control apparatus configured to include: a processor configured to generate a candidate path group to a destination, when an autonomous driving section and a section requiring remote control are included in the candidate path group, to request a remote driving reservation to the control system, receive a path selected from the candidate path group by a user depending on availability of a remote driving reservation of the control system and estimated fare, and control the vehicle to follow the selected path, and when the vehicle reaches the section requiring remote control, to control the vehicle depending on remote control of the control system; and a communication device configured to communicate with the control system.

In an exemplary embodiment, the processor may generate a final path candidate group in the candidate path group depending on the availability of the remote driving reservation received from the control system and the estimated fare, and the autonomous driving control apparatus may further include an interface device configured to display the final path candidate group.

In an exemplary embodiment, the processor may calculate a fare by applying a predetermined weight to a driving time of the autonomous driving section and a driving time of the section requiring remote control. The processor may further generate the candidate path group in the order of lowest fare.

In an exemplary embodiment, the processor may generate the candidate path group in the case of at least one of an initial input of a destination, a change of the destination, or an increase in fare compared to an existing path.

In an exemplary embodiment, the processor may calculate a start time of a remote driving requiring section for each candidate path and an end time of a remote driving requiring section for each candidate path when generating the candidate path group.

In an exemplary embodiment, the processor may transmit, to the control system, at least one of a start time of the remote driving requiring section for each candidate path, an end time of the remote driving requiring section for each candidate path, a path of a remote driving requiring section, or vehicle data when requesting the remote driving reservation to the control system.

In an exemplary embodiment, the processor may generate paths that receive reservation progress flags from the control system as a final path candidate group.

In an exemplary embodiment, the processor may transmit a reservation confirmation flag of a path selected by a user in the final path candidate group to the control system. The processor may further display the path selected by the user as the final path on the interface device when receiving the reservation completion flag from the control system.

In an exemplary embodiment, the processor may perform autonomous driving by following the final path. When a start point of the remote control required section is reached, the processor may receive a remote driving start signal from the control system and control the vehicle depending on a remote control command received from the control system.

In an exemplary embodiment, the processor, when driving of the section requiring remote control ends, may display a remote driving fare on the interface device and may display a screen indicating that autonomous driving is in progress.

In an exemplary embodiment, the processor may display a screen indicating that a fare is generated on the interface device when re-reserving a path after canceling it during remote driving.

An exemplary embodiment of the present disclosure provides a control system including: a processor configured to check whether a reservation for a section requiring remote control is available, calculate an estimated fare, and transmit it to the autonomous vehicle when receiving a remote driving reservation request for a path including an autonomous driving section and a section requiring remote control from an autonomous vehicle, and to confirm the reservation to transmit it to the autonomous vehicle when a reservation confirmation for the path selected by a user is requested from the autonomous vehicle depending on the reservation availability and the estimated fare; and a communication device configured to communicate with the autonomous vehicle.

In an exemplary embodiment, the processor may check whether the reservation for the section requiring remote control is available based on occupancy of a remote driving control device at a start time of the section requiring remote control and whether driving of the section requiring remote control is possible.

In an exemplary embodiment, the processor may proceed reservations in order of smallest occupancy on a same day in the remote driving control device.

In an exemplary embodiment, the processor may transmit a remote driving reservation progress result and an estimated fare for each path requested for remote control to the autonomous vehicle.

In an exemplary embodiment, the processor may confirm the reservation when a reservation confirmation flag is received from the autonomous vehicle within a predetermined time after the remote driving reservation progress result and the estimated fare are transmitted to the autonomous vehicle.

In an exemplary embodiment, the processor may initialize all reservation progress flags other than the path for which the reservation is confirmed and may transmit a reservation completion flag for the path for which the reservation is confirmed to the autonomous vehicle.

In an exemplary embodiment, the processor may start remote control and transmit a remote driving start signal to the autonomous vehicle when the start time of the section requiring remote control is reached.

In an exemplary embodiment, the processor may determine whether an extension reservation of an allocated remote control device is possible until a recalculated expected remote control end time when the autonomous vehicle does not reach the section requiring remote control within a reserved time and may transmit a reservation cancellation flag to the autonomous vehicle when the extension reservation is impossible.

An exemplary embodiment of the present disclosure provides a remote control method for an autonomous vehicle, including: generating a candidate path group to a destination; requesting a remote driving reservation to a control system when an autonomous driving section and a section requiring remote control are included in the candidate path group; receiving a selection of a final path depending on remote driving reservation availability of the control system and an estimated fare; and following and controlling the selected path, and performing vehicle control depending on remote control of the control system when the vehicle reaches the section requiring remote control.

According to embodiments of the present disclosure, when generating a path including an autonomous driving control section and a section requiring remote control, remote control may be performed by a control system at start of driving in the section requiring remote control after driving in the autonomous driving control section, and the autonomous driving control may be performed again at end of the section requiring remote control by making a reservation by determining whether it is possible to reserve the section requiring remote control, thereby increasing convenience and reliability of an autonomous vehicle.

In addition, various effects that can be directly or indirectly identified through this document may be provided.

As discussed, the method and apparatus suitably include use of a controller or processer.

In another aspect, vehicles are provided that comprise an apparatus as disclosed herein.

In a fully autonomous vehicle or system, the vehicle may perform all driving tasks under all conditions and little or no driving assistance is required a human driver. In a semi-autonomous vehicle, for example, the automated driving system may perform some or all parts of the driving task in some conditions, but a human driver regains control under some conditions, or in other semi-autonomous systems, the vehicle's automated system may oversee steering and accelerating and braking in some conditions, although the human driver is required to continue paying attention to the driving environment throughout the journey, while also performing the remainder of the necessary tasks.

In certain aspects, the present apparatus, systems and vehicles may be fully autonomous. In other certain aspects, the present apparatus, systems and vehicles may be semi-autonomous.

### BRIEF DESCRIPTION OF THE DRAWINGS

FIG. 1 illustrates a block diagram showing a configuration of an autonomous apparatus and a control system according to an exemplary embodiment of the present disclosure.

FIG. 2 illustrates an example of a screen for checking a final path candidate group according to an exemplary embodiment of the present disclosure.

FIG. 3 illustrates an example of a screen showing a remote driving reservation status board according to an exemplary embodiment of the present disclosure.

FIG. 4 illustrates a flowchart showing a remote control flow between an autonomous vehicle and a control system according to an exemplary embodiment of the present disclosure.

FIG. 5A and FIG. 5B illustrate flowcharts for describing a remote control method of an autonomous vehicle according to an exemplary embodiment of the present disclosure.

FIG. 6A and FIG. 6B illustrate flowcharts for describing a remote control method of a control system according to an exemplary embodiment of the present disclosure.

FIG. 7 illustrates a computing system according to an exemplary embodiment of the present disclosure.

### DETAILED DESCRIPTION

It is understood that the term “vehicle” or “vehicular” or other similar term as used herein is inclusive of motor vehicles in general and includes vehicles with internal combustion engines as well as electric vehicles and other alternative fuel vehicles (e.g., fuels derived from resources other than petroleum).

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components or combinations thereof.

Further, the control logic of embodiments of the present disclosure may be embodied as non-transitory computer readable media on a computer readable medium containing executable program instructions executed by a processor, controller, or the like. Examples of computer readable media include, but are not limited to, ROM, RAM, compact disc (CD)-ROMs, magnetic tapes, floppy disks, flash drives, smart cards, and optical data storage devices. The computer readable medium can also be distributed in network coupled computer systems so that the computer readable media is stored and executed in a distributed fashion, e.g., by a telematics server or a Controller Area Network (CAN).

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. In addition, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the technical field to which the present disclosure pertains (those skilled in the art) unless they are differently defined. Terms defined in a generally used dictionary shall be construed to have meanings matching those in the context of a related art and shall not be construed to have idealized or excessively formal meanings unless they are clearly defined in the present specification.

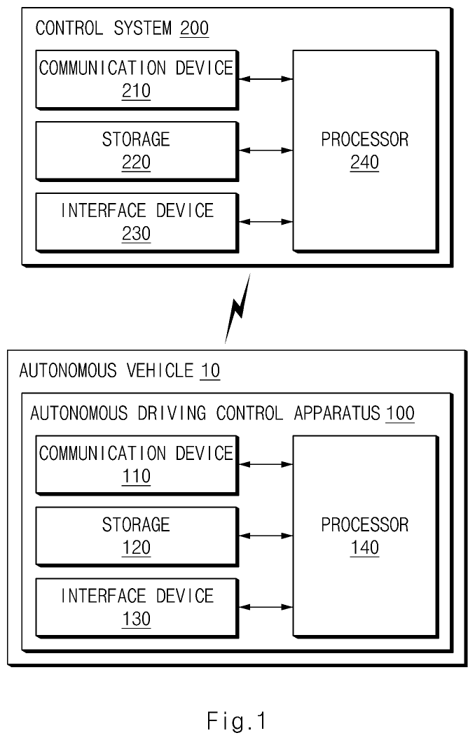

Hereinafter, exemplary embodiments of the present disclosure will be described in detail with reference to FIG. 1 to FIG. 7.

FIG. 1 illustrates a block diagram showing a configuration of an autonomous apparatus and a control system that performs remote control of the autonomous vehicle according to an exemplary embodiment of the present disclosure.

Referring to FIG. 1, remote control may be performed between an autonomous apparatus 10 and a control system 200 through communication.

The autonomous vehicle 10 may include an autonomous driving control apparatus 100 configured to perform an autonomous driving function that generates a path for a vehicle to control the vehicle without driver intervention, and a remote control function that controls the vehicle depending on a remote control command of the control system 200. As an example, the autonomous driving control apparatus 100 may include an advanced driver assistance system (ADAS), a smart cruise control (SCC), or the like.

The autonomous driving control apparatus 100 according to the exemplary embodiment of the present disclosure may be implemented inside the vehicle. In this case, the autonomous driving control apparatus 100 may be integrally formed with internal control units of the vehicle or may be implemented as a separate device to be connected to control units of the vehicle by a separate connection means.

The autonomous driving control apparatus 100 may generate a candidate path group to a destination; when a section requiring remote control is included in the candidate path group, may request a remote driving reservation to the control system 200, finally select the path depending on availability of a remote driving reservation of the control system 200 and fare, and control the vehicle to follow the selected path; and when the vehicle reaches the section requiring remote control, control the vehicle depending on remote control of the control system 200.

Referring to FIG. 1, the autonomous driving control apparatus 100 may include a communication device 110, a storage 120, an interface device 130, and a processor 140.

The communication device 110 may be a hardware device implemented with various electronic circuits to transmit and receive signals through a wireless or wired connection and may transmit and receive information based on in-vehicle devices and in-vehicle network communication techniques. As an example, the in-vehicle network communication techniques may include controller area network (CAN) communication, local interconnect network (LIN) communication, flex-ray communication, or the like. Herein, the wireless communication technique may include wireless LAN (WLAN), wireless broadband (Wibro), Wi-Fi, world interoperability for microwave access (Wimax), etc.

For example, the communication device 110 may transmit a remote reservation request, a vehicle path, a remote driving path, a remote driving start time, a remote driving end time, vehicle data, or the like to the control system 200. In this case, the vehicle data may include vehicle sensor data, image data, or the like. Although a configuration of a sensing device is not disclosed in FIG. 1, the sensing device may be further included.

The storage 120 may store data and/or algorithms required for the processor 140 to operate, or the like. As an example, the storage 120 may store a path candidate group, a final path candidate group, or a remote control command received from the control system 200.

The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, or an optical disk.

The interface device 130 may include an input means for receiving a control command from a user and an output means for outputting an operation state of the apparatus 100 and results thereof. Herein, the input means may include a key button, and may further include a mouse, a keyboard, a touch screen, a microphone, a joystick, a jog shuttle, a stylus pen, or the like. In addition, the input means may further include a soft key implemented on the display.

The interface device 130 may be implemented as a head-up display (HUD), a cluster, an audio video navigation (AVN), a human machine interface (HM), a user setting menu (USM), or the like.

The output means may include a display and may further include a voice output means such as a speaker. In this case, when a touch sensor formed of a touch film, a touch sheet, or a touch pad is provided on the display, the display may operate as a touch screen, and may be implemented in a form in which an input device and an output device are integrated.

In this case, the display may include at least one of a liquid crystal display (LCD), a thin film transistor liquid crystal display (TFT LCD), an organic light emitting diode display (OLED display), a flexible display, a field emission display (FED), or a 3D display.

For example, the interface device 130 may display data transmitted and received with respect to the control system 200, a driving path of the vehicle, a remote control command received from the control system 200, or the like. In addition, the interface device 130 may display the final path candidate group including fare information for each path received from the control system 200 to receive one path in the final path candidate group selected by a user. In addition, the interface device 130 may display status information such as remote control start, remote control end, autonomous driving control start, autonomous driving control end, remote control reservation completion, or the like.

The processor 140 may be electrically connected to the communication device 110, the storage 120, the interface device 130, or the like, may electrically control each component, and may be an electrical circuit that executes software commands, thereby performing various data processing and calculations described below. The processor 140 may process a signal transferred between components of the autonomous driving control apparatus 100 and may perform overall control such that each of the components can perform its function normally.

The processor 140 may be implemented in the form of hardware, software, or a combination of hardware and software, or may be implemented as microprocessor, and may be, e.g., an electronic control unit (ECU), a micro controller unit (MCU), or other subcontrollers mounted in the vehicle.

The processor 140 may generate a candidate path group to a destination; when an autonomous driving section and a section requiring remote control are included in the candidate path group, may request a remote driving reservation to the control system, receive the path selected by a user depending on availability of the remote driving reservation of the control system and estimated fare, and control the vehicle to follow the selected path; and when the vehicle reaches the section requiring remote control, may control the vehicle depending on remote control of the control system.

The processor 140 may generate the candidate path group in the case of at least one of an initial input of a destination, a change of the destination, or an increase in fare compared to an existing path.

The path candidate group may include only an autonomous driving control section, only a remote driving requiring section, or a candidate path including both the autonomous driving control section and the remote driving requiring section.

In addition, the processor 140 may receive a path generation priority in advance through a user setting manual (USM) from a user of the autonomous vehicle 10 or a manager of the autonomous vehicle 10 in order to generate a candidate path. For example, when autonomous driving is set as priority, the autonomous vehicle 10 may generate a path by preferentially including a section in which autonomous driving is possible when generating the path.

The processor 140 may generate some of cheapest and fastest sections as candidate paths in a situation in which the user is not driving and may list the candidate paths in the order of cheapest.

The processor 140 may calculate a fare by applying a predetermined weight to a driving time of the autonomous driving section and a driving time of the section requiring remote control and may generate candidate path groups in the order of lowest fare.

The processor 140 may calculate a fare for each path as shown in Equation 1 below. (Equation 1)

Fare=a*autonomous driving time+(1−a)*remote driving time(0<=a<=0.5, and a indicates a weight which varies depending on a USM setting value)

The processor 140 may compare the autonomous driving time and the remote driving time equally when a=0.5 and give more weight to the autonomous driving time when a<0.5. In other words, even when a total driving time becomes longer, autonomous driving may take longer.

In addition, when a=0, the processor 140 may give priority to a path having a short remote driving time, regardless of the autonomous driving time.

The processor 140 may sort and store at least one path data having a low fare in the storage 120.

In addition, the processor 140 may generate the candidate path by continuously checking road conditions of a driving path while driving as well as when the autonomous vehicle first sets a destination. In addition, the processor 140 may re-generate the path candidate group when a recalculated fare of an existing path is higher than an initial fare of the existing path due to an increase in traffic volume on the existing path by a specific level or more.

The processor 140 may transmit vehicle data for remote control to the control system 200, and when receiving a remote control command for remote control from the control system 200, may control the vehicle based on the received remote control command. In this case, the vehicle data may include at least one of image information around the vehicle, surrounding object information, a position of the vehicle, a vehicle path, speed information of the vehicle, indoor image information, or map information. In addition, the remote control command may include at least one of vehicle speed control, moving direction control, ignoring a misrecognized object, changing a lane, ignoring a maximum road speed, ignoring a traffic signal, or responding to a hand signal.

The processor 140 may generate a final path candidate group, depending on availability of a remote driving reservation and estimated fare received from the control system among the candidate path groups.

That is, the processor 140 may generate the final path candidate group as a path that can be reserved for remote driving. When a path including a remote driving requiring section (section requiring remote control) exists among at least one path candidates with low fares, the processor may estimate a time of arrival at the remote driving requiring section and request the control system 200 to check whether remote driving can be reserved at that time.

That is, when the remote driving reservation is requested, the processor 140 should transmit vehicle information, a remote driving reservation start time and a remote driving reservation end time, and remote driving path information to a reservation management system of a control center.

In this case, as shown in Equation 2 below, the processor 140 may calculate the remote driving reservation start time, the remote driving reservation end time (end time of the remote driving requiring section for each candidate path), and the remote driving requiring time (start time of the remote driving requiring section for each candidate path).

Remote driving reservation start time=Remote driving requiring time−Remote driving start buffer time

Remote driving reservation end time=Estimated remote driving end time+Remote driving end buffer time

Remote driving requiring time=current time+time required to arrive at remote driving requiring section (Equation 2)

For example, when a current time is 2 o'clock and the required time to the remote driving requiring section is 30 min, the remote driving may be estimated to start at 2:30 pm.

In this case, the remote driving start buffer time indicates a spare time allotted to prepare for the remote driving that needs to be able to start before the remote driving requiring section and the remote driving start time that may vary depending on a driving condition.

The estimated remote driving end time indicates a time when remote driving is expected to end when remote driving is performed in a relevant section when a remote driving start point is reached. For example, when a vehicle that started remote driving at 2:30 is expected to arrive at 3 o'clock in consideration of a congestion level at that time, the expected end time is 3 o'clock.

The remote driving end buffer time indicates a time to secure a spare time because remote driving may be longer depending on a driving condition.

The processor 140 may generate a final path candidate group upon receiving reservation availability from the control system 200. That is, when all necessary remote driving can be reserved in one candidate path, the processor 140 may determine the path as the final path candidate group and may store the determined path in the storage 120. In addition, when all reservation progress success flags for remote driving requested in one candidate path are received, the processor 140 may select the corresponding path as the final path candidate group.

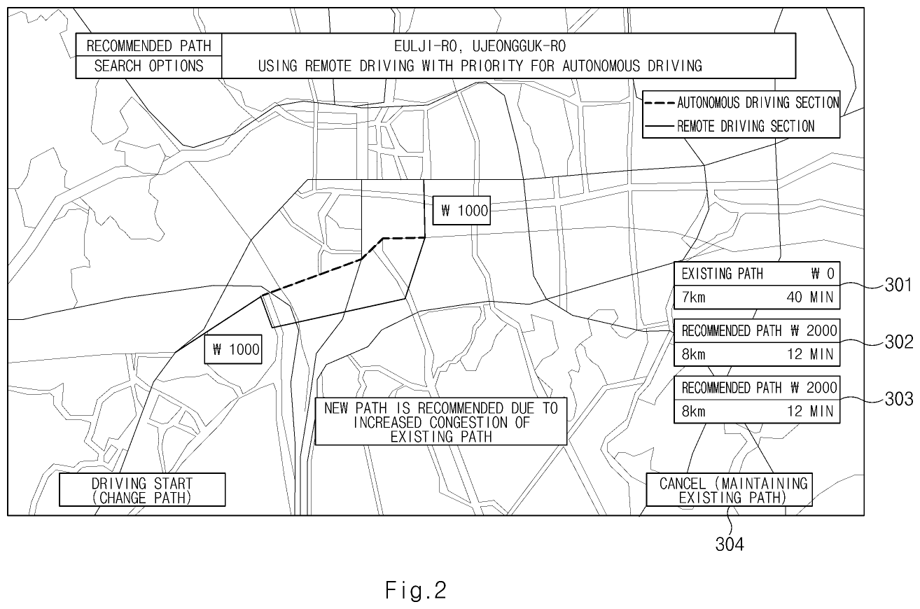

As shown in FIG. 2, the processor 140 may display a screen regarding the final path candidate group on the interface device 130 to receive one desired path selected by a user in the final path candidate group. In FIG. 2, a distance, a required time, and fare of each of an existing path 301, a recommended path 302, and a fast path 303 may be displayed, and the user may select one of them. FIG. 2 illustrates an example of a screen for checking a final path candidate group according to an exemplary embodiment of the present disclosure.

In this case, the processor 140 may list up paths in the order of lower fare, and embodiments of the present disclosure are not limited thereto, and the paths may be listed based on an option with high importance among the required time, search options, fares, and paths depending on a user setting.

In addition, when a cancel button 304 is selected by the user in FIG. 2, no path may be selected, and in this case, an existing path may be maintained or path search may be performed again.

The processor 140 may determine whether one of the existing path 301, the recommended path 302, and the fast path 303 of FIG. 2 is selected before a predetermined time is exceeded, before starting a remote driving requiring section after making a remote driving reservation, and when there is no selection, may perform initialization and transmit a reservation cancellation flag to the control system 200.

When the final path is selected by the user, the processor 140 may transmit a reservation confirmation flag for the selected path to the control system 200.

When receiving a reservation completion flag from the control system 200, the processor 140 may display the path selected by the user on the interface device 130 as the final path.

When receiving the reservation completion flag from the control system 200, the processor 140 may output a screen notifying that the vehicle will travel on the path selected by the user through the interface device 130. In addition, the processor 140 may display an autonomous driving section, a remote driving section, a total distance, a required time, a fare, or the like of the path selected by the user on the notification screen. In addition, the processor 140 may output, through the interface device 130, a screen informing that a fare may be generated when the path is canceled and reserved during remote driving.

The processor 140 may perform autonomous driving by following the final path, may receive a remote driving start signal from the control system 200 when reaching a start point of the section requiring remote control, and may control the vehicle depending on a remote control command received from the control system 200.

The processor 140 may display a remote driving fare on the interface device 130 and may display a screen indicating that autonomous driving is in progress when driving of the section requiring remote control ends.

The processor 140 may display, on the interface device 130, a screen informing that a fare is generated when making a reservation again after canceling the path during remote driving.

Meanwhile, when receiving a remote driving reservation request for a path including an autonomous driving section and a section requiring remote control from the autonomous vehicle 10, the control system 200 may check whether a reservation for a section requiring remote control is available, may calculate an estimated fare, and may transmit it to the autonomous vehicle, and when a reservation confirmation for the path selected by the user is requested from the autonomous vehicle 10 depending on the reservation availability and the estimated fare, confirm the reservation to transmit it to the autonomous vehicle.

A control manager may directly perform remote control by checking vehicle data received from the autonomous vehicle 10 through the screen of the control system 200 and selecting a remote control command. In this case, the control manager is a person who is authorized to access the control system 200 and may be disposed in a place that the access to the control system 200 is possible, such as an office inside the vehicle or outside the vehicle.

To this end, the control system 200 may include a communication device 210, a storage 220, an interface device 230, and a processor 240.

The communication device 210 may be a hardware device implemented with various electronic circuits to transmit and receive signals through a wireless or wired connection. The communication device 210 may perform wireless communication with the autonomous vehicle 10 based on wireless communication technique, and the wireless communication technique may include wireless LAN (WLAN), wireless broadband (Wibro), Wi-Fi, world Interoperability for microwave access (Wimax), etc. For example, the communication device 210 may receive a remote reservation request, a vehicle path, a remote driving path, a remote driving start time, a remote driving end time, vehicle data, etc. from the autonomous vehicle 10, and may transmit a reservation progress flag, a reservation completion flag, a remote control start flag, a remote control end flag, and whether a reservation is possible (a reservation progress flag, an estimated fare, etc.) to the autonomous vehicle 10.

The storage 220 may store vehicle data received from the autonomous vehicle 10, data and/or algorithm required for the processor 240 to operate, or the like.

As an example, the storage 220 may store a vehicle path, a remote driving path, a start time of a remote driving path, an end time of the remote driving path, or an estimated fare for each path, etc. received from the autonomous vehicle 10.

The storage 220 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, or an optical disk.

The interface device 230 may include an input means for receiving a control command from a control manager and an output means for outputting a remote control state and results thereof. Herein, the input means may include a key button, and may further include a mouse, a keyboard, a touch screen, a microphone, a joystick, a jog shuttle, a stylus pen, or the like. In addition, the input means may further include a soft key implemented on the display.

The output means may include a display and may further include a voice output means such as a speaker. In this case, when a touch sensor formed of a touch film, a touch sheet, or a touch pad is provided on the display, the display may operate as a touch screen, and may be implemented in a form in which an input device and an output device are integrated. In this case, the display may include at least one of a liquid crystal display (LCD), a thin film transistor liquid crystal display (TFT LCD), an organic light emitting diode display (OLED display), a flexible display, a field emission display (FED), or a 3D display.

For example, the interface device 230 may receive selection of one remote control command in the remote control command list from the control manager by using a mouse or a touch method to transfer the selected remote control command to the processor 240.

For example, the interface device 230 may include all communication terminals such as a personal computer (PC), a notebook computer, a smartphone, a tablet PC, a pad, a personal digital assistant (PDA), and a wearable device.

The processor 240 may be electrically connected to the communication device 210, the storage 220, the interface device 230, or the like, may electrically control each component, and may be an electrical circuit that executes software commands, thereby performing various data processing and calculations described below.

The processor 240 of the control system 200 may check whether the section requiring remote control can be reserved based on occupancy of a remote control device at the start time of the section requiring remote control and driving availability of the section requiring remote control.

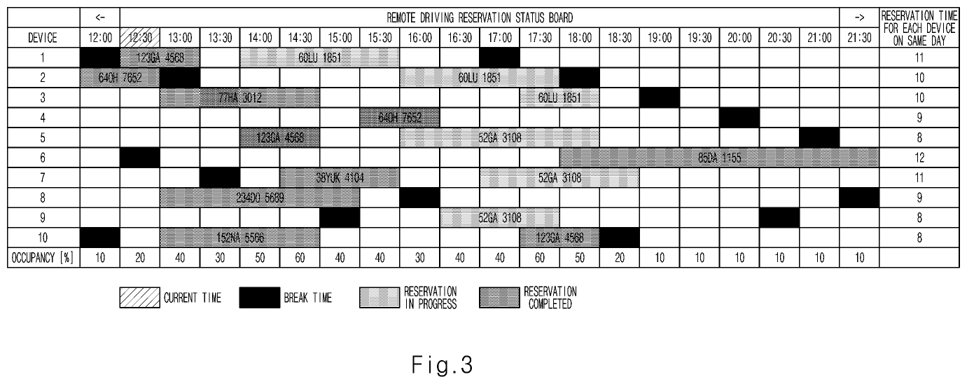

That is, when a remote control reservation request is received from the autonomous vehicle 10, the processor 240 may transmit a reservation progress flag to a remote driving control device that can be reserved at a corresponding time. In this case, when the corresponding device is being reserved at a specific time, another vehicle cannot make a reservation at that time. A remote control occupancy time may be stored in the storage 220, and a real-time reservation status may be checked on a status board as shown in FIG. 3. Reservation progress flags are transmitted in the order with smallest reservation time for each device on a same day among all remote driving control devices, so that reservations can be equally allocated to each device.

When the reservation progress flag can be transmitted, the processor 240 may transmit a reservation progress success flag for a corresponding reservation request to the autonomous vehicle 10. In the meantime, the processor 240 may transmit a reservation progress failure flag when occupancy of a remote driving control device exceeds x % at a reservation request time or a driving path includes a section where remote driving is not possible. In addition, the processor 240 may leave a margin such that another remote driving control device can be used when previously ongoing remote driving ends late or the vehicle arrives late. In this case, the processor 240 may calculate the occupancy by considering the reservation progress flag as a reservation. As illustrated in FIG. 3, the control manager may input his/her non-business hours to receive reservations only during business hours. FIG. 3 illustrates an example of a screen showing a remote driving reservation status board according to an exemplary embodiment of the present disclosure.

In addition, the processor 240 may set an estimated fare for each path. That is, the processor 240 may set a fare for the remote control reservation request depending on an expected remote driving execution time. In this case, the processor 240 may calculate the expected remote driving execution time by calculating the driving required time in consideration of road congestion in a remote driving reservation time zone. In addition, the processor 240 may transmit an estimated fare for the reservation request for which the reservation is successful to the autonomous vehicle 10 through the communication device 210.

In addition, when receiving the reservation confirmation flag from the autonomous vehicle 10, the processor 240 may confirm the reservation of the corresponding path, may initialize reservation progress flags depending on other reservation requests transmitted from the corresponding vehicle 10, and may transmit a reservation completion flag to the corresponding autonomous vehicle 10.

The processor 240 may initialize the reservation progress flags for all reservation requests received from the autonomous vehicle 10 when receiving a reservation cancellation flag from the autonomous vehicle 10 or no reservation confirmation flag for a remote driving request for a predetermined time.

When the vehicle does not arrive at the remote driving requiring section within a reserved time due to changes in road conditions, etc., that is, when an arrival time of the remote driving requiring section and the expected remote driving execution time exceed an existing expected remote driving end time, the remote driving may not be performed for the existing remote driving reservation request.

Accordingly, the processor 240 may check whether a remote control assignment device can extend the reservation until a recalculated expected remote control end time. When an extension reservation is made, the processor 240 may maintain the reservation, and may change the end time.

In addition, when the remote control assignment device has another reservation after the existing expected remote driving end time, the processor 240 may check availability of another device for the another reservation, and when there is an available device, may transfer the reservation to the corresponding device.

On the other hand, when there is no other remote driving control device available, the processor 240 may transmit a reservation cancellation flag to the autonomous vehicle 10. Accordingly, the autonomous vehicle 10 may re-search and operate a path capable of preferentially autonomous driving at the corresponding position and may notify the user that the path has been changed.

That is, when the autonomous vehicle does not reach the section requiring remote control within the reserved time, the processor 240 may determine whether an extension reservation of the allocated remote control device is possible until the recalculated expected remote control end time, and when the extension reservation is impossible, may transmit a reservation cancellation flag to the autonomous vehicle 10.

For the control system 200, in the case where a time when remote driving is reserved comes, the control manager may directly start remote driving control in the autonomous driving section (before entering the remote driving requiring section). As such, when the remote driving control is started, the processor 240 may transmit a remote driving start flag to the autonomous vehicle 10. Accordingly, when receiving the remote driving start flag, the autonomous vehicle 10 may display it on the interface device 130 that the vehicle is being remotely controlled.

In this case, the autonomous vehicle 10 may transmit vehicle data (image, autonomous driving recognition sensor information, etc.) to the control system 200, and the control manager may check the received vehicle data and directly perform remote control with a joystick. Thereafter, when the remote driving is ended, the processor 240 may transmit a remote driving end flag to the autonomous vehicle 10.

Meanwhile, when the autonomous vehicle 10 does not receive the remote driving start flag because the control manager does not start the remote driving control in the remote driving requiring section, the autonomous vehicle 10 may re-search the path in the autonomous driving section.

In addition, when the remote driving is ended, the processor 240 may charge a fare in proportion to the remote driving execution time. In addition, when an occupant cancels the path while performing remote driving, the processor 240 may charge a fare for the remote driving execution time and a cancellation fare for the remaining reservation time.

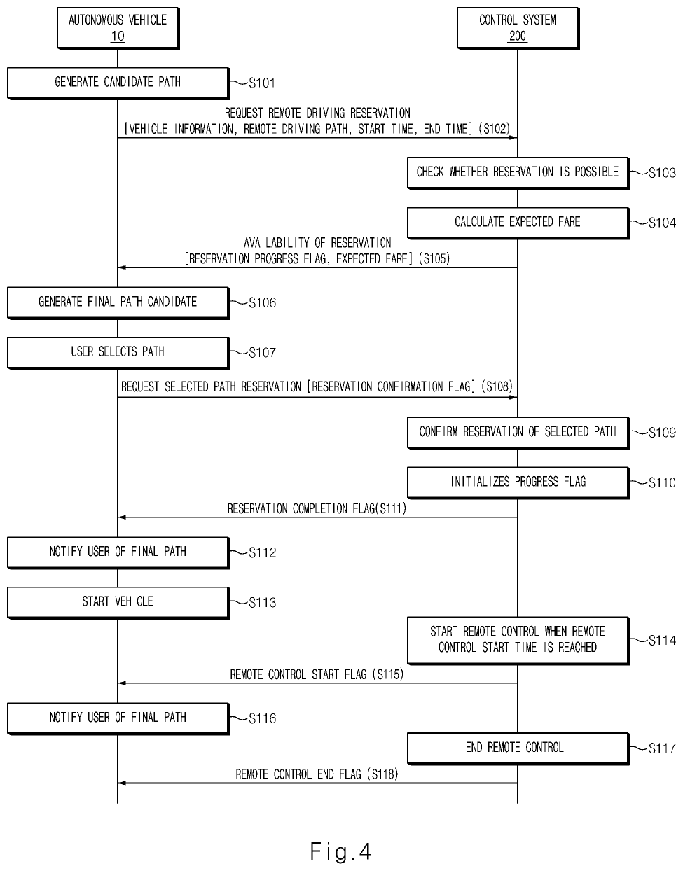

Hereinafter, a remote control method for an autonomous vehicle according to an exemplary embodiment of the present disclosure will be described in detail with reference to FIG. 4. FIG. 4 illustrates a remote control method for an autonomous vehicle according to an exemplary embodiment of the present disclosure.

Hereinafter, it is assumed that the autonomous vehicle 10 and the control system 200 of FIG. 1 may perform processes of FIG. 4. In addition, in the description of FIG. 4, it may be understood that operations described as being performed by the autonomous vehicle 10 and the control system 200 may be controlled by a processor of each device.

Referring to FIG. 4, the autonomous vehicle 10 may generate a candidate path to a destination (S101). That is, the autonomous vehicle 10 may monitor the path to the destination and may generate an optimal path candidate group including the remote driving section and the autonomous driving section.

Then, when there is a path candidate requiring remote control, the autonomous vehicle 10 may perform a remote driving reservation request to the control system 200 to check whether remote control is possible at a corresponding time (S102). In this case, the autonomous vehicle 10 may transmit vehicle information, a remote driving path, a start time, an end time, etc. together when the remote driving reservation request is performed.

Accordingly, the control system 200 may check whether a reservation is possible with respect to the reservation request received from the autonomous vehicle 10 (S103). That is, when receiving the remote control reservation request, the control system 200 may determine whether remote control is possible for a reservation request time and section requested by the autonomous vehicle 10 based on a remote control reservation status board as shown in FIG. 3, and when performing the remote control, calculate an estimated fare (S104).

Then, the control system 200 transmits a result (reservation progress flag) and an estimated fare for availability of the reservation to the autonomous vehicle 10 (S105).

Accordingly, the autonomous vehicle 10 may generate a final path candidate (S106), display the final path candidate together with the estimated fare for each path, and receive a final path selected by the user (S107).

Then, the autonomous vehicle 10 may transmit the selected path to the control system 200 to request reservation of the selected path (S108).

Accordingly, the control system 200 may confirm the reservation of the selected path received from the autonomous vehicle 10 (S109), initialize a reservation progress flag depending on another reservation request received from the corresponding autonomous vehicle 10 (S110), and transmit a reservation completion flag of the selected path to the autonomous vehicle 10 to complete the reservation (S111).

Then, the autonomous vehicle 10 may notify the user of the final path (S112) and start driving to follow the final path (S113).

Accordingly, for the control system 200, in the case where a time when remote driving is reserved, that is, when the remote driving is started, comes, the control manager may directly start remote driving control in the autonomous driving section (before entering the remote driving requiring section) (S114). In this case, the control system 200 may use the vehicle data (images, autonomous driving recognition sensor information, etc.) received from the autonomous vehicle 10, and the control manager may directly perform remote control with a joystick or the like.

As such, when the remote driving control is started, the control system 200 may transmit the control system remote driving start flag to the autonomous vehicle 10 (S115). Accordingly, when receiving the remote driving start flag, the autonomous vehicle 10 may display it on the interface device 130 that the vehicle is being remotely controlled (S116). Thereafter, the control system 200 may transmit a remote driving end flag to the autonomous vehicle 10 when the remote driving is terminated (S117).

Accordingly, the autonomous vehicle 10 may be switched to an autonomous driving control mode to continue autonomous driving.

When receiving the reservation completion flag from the control system 200, the autonomous vehicle 10 may notify it is driven along the path selected by the user through the interface device 130. In this case, the interface device 130 may display an autonomous driving section, a remote driving section, a total distance, a required time, and a fare of the path selected by the user. In addition, the interface device 130 may output a screen informing that a fare may be generated when the path is canceled and reserved during remote driving.

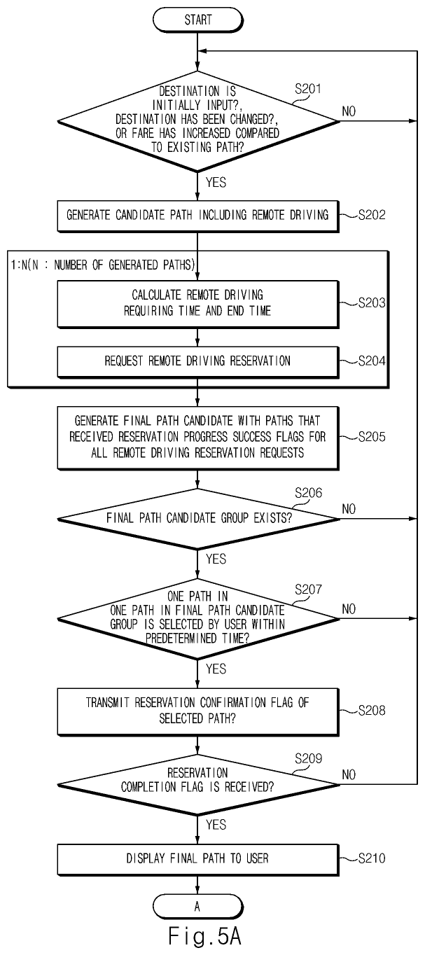

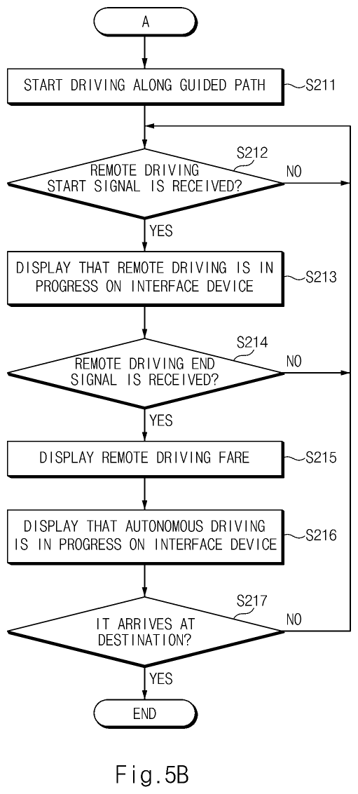

Hereinafter, a remote control method for an autonomous vehicle according to an exemplary embodiment of the present disclosure will be described in detail with reference to FIG. 5A and FIG. 5B. FIG. 5A and FIG. 5B illustrate flowcharts for describing a remote control method of an autonomous vehicle according to an exemplary embodiment of the present disclosure. Hereinafter, it is assumed that the autonomous driving control apparatus 100 of the autonomous vehicle 10 of FIG. 1 may perform the processes of FIG. 5A and FIG. 5B.

In addition, in the description of FIG. 5A and FIG. 5B, it may be understood that operations described as being performed by the autonomous driving control apparatus 100 are controlled by a processor of each device.

First, referring to FIG. 5, the autonomous driving control apparatus 100 may determine whether a destination is initially input, whether the destination has been changed, whether a fare has increased compared to an existing path (S201), and generate a candidate path including remote driving when the destination is initially input, the destination is changed, or the fare is increased compared to the existing path (S202).

The autonomous driving control apparatus 100 may calculate a remote driving requiring time and a remote driving end time (S203) and request a remote driving reservation to the control system 200 (S204).

The autonomous driving control apparatus 100 may generate, as a final path candidate group, paths that have received a remote reservation progress success flag from the control system 200 among paths that have requested remote driving reservation (S205), determine whether a final path candidate group exists (S206), and when the final path candidate group, and display the final path candidate group on the interface device 130 to determine whether one path in the final path candidate group is selected by the user within a predetermined time (S207).

When one path from the final path candidate group is selected, the autonomous driving control apparatus 100 may transmit a reservation confirmation flag of the selected path to the control system 200 (S208) and determine whether a reservation completion flag is received from the control system 200 (S209).

When the reservation completion flag is received from the control system 200, the autonomous driving control apparatus 100 displays the final path through the interface device 130 (S210).

Then, referring to FIG. 5B, the autonomous driving control apparatus 100 may start driving control by following the guided final path (S211). In this case, the autonomous driving control apparatus 100 may determine whether a remote driving start signal is received from the control system 200 (S212), and when the remote driving start signal is received, display that the remote driving is in progress on the interface device 130 (S213).

Thereafter, the autonomous driving control apparatus 100 may determine whether a remote driving end signal is received from the control system 200 (S214), and when the remote driving end signal is received, display a remote driving fare on the interface device 130 (S215).

Then, the autonomous driving control apparatus 100 may display on the interface device 130 that the remote driving is ended and autonomous driving is in progress (S216) determine whether the vehicle has arrived at the destination (S217), and end it when the destination is reached.

As such, the autonomous vehicle 10 of embodiments of the present disclosure may efficiently perform autonomous driving control by generating a driving path including both autonomous driving and remote driving. That is, the autonomous vehicle 10 may continue to perform vehicle control without user driving through remote control in a section where autonomous driving is impossible, and when congestion occurs in a section where autonomous driving is possible, the vehicle may be controlled to be driven to bypass through remote driving control, thereby shortening an entire travel time.

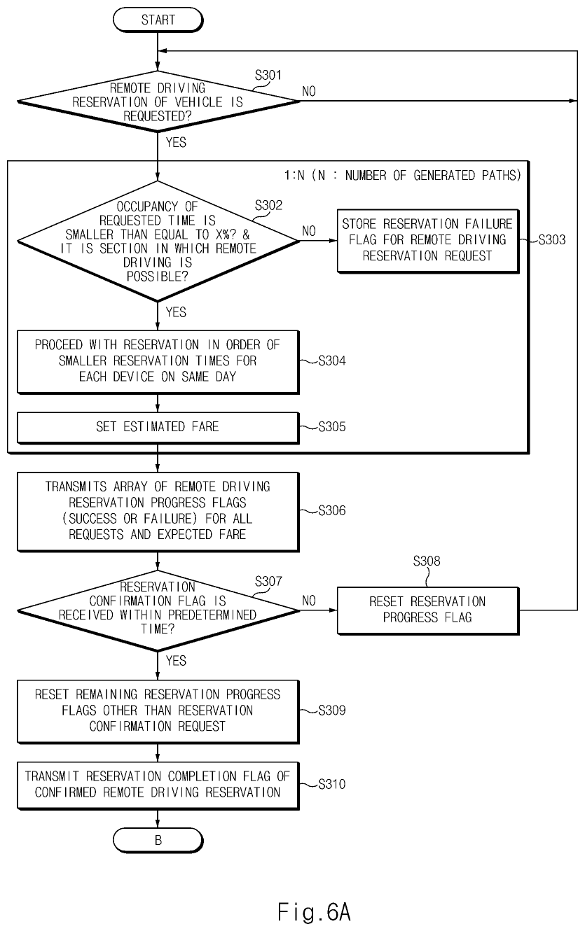

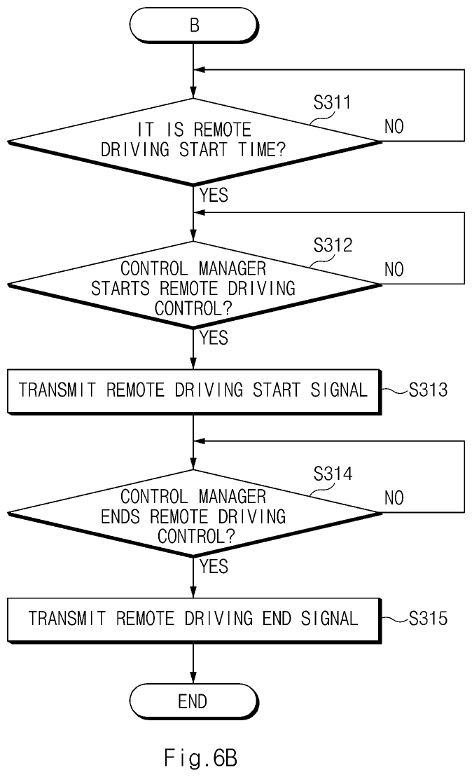

Hereinafter, a remote control method for a control system according to an exemplary embodiment of the present disclosure will be described in detail with reference to FIG. 6A and FIG. 6B. FIG. 6A and FIG. 6B illustrate flowcharts for describing a remote control method of a control system according to an exemplary embodiment of the present disclosure.

Hereinafter, it is assumed that the control system 200 of FIG. 1 may perform the processes of FIG. 6A and FIG. 6B. In addition, in the description of FIG. 6A and FIG. 6B, it may be understood that operations described as being performed by the control system 200 are controlled by a processor thereof.

First, referring to FIG. 6A, the control system 200 may check whether there is a request for a remote driving reservation from the autonomous vehicle 10 (S301), when there is the request for the remote driving reservation from the autonomous vehicle 10, determine whether occupancy of a remote driving control device at a time when remote driving is required is smaller than or equal to a predetermined reference value, and determine whether the remote driving requiring section requested by the autonomous vehicle 10 is a section in which remote driving is possible (S302).

When the occupancy of the remote driving control device at the time when remote driving is required exceeds the predetermined reference value or the remote driving requiring section requested by the autonomous vehicle 10 is the section in which the remote driving is possible, the control system 200 may transmit a reservation failure flag for the remote driving reservation request to the autonomous vehicle 10 (S303).

On the other hand, when the occupancy of the remote driving control device at the time when remote driving is required is smaller than or equal to the predetermined reference value and the remote driving requiring section for which the remote control reservation has been requested is the section in which the remote driving is possible, the control system 200 proceeds with the reservation in the order of smaller reservation times for each device on the same day (S304).

Then, the control system 200 may set an estimated fare for the remote control (S305) and transmit an array of remote driving reservation progress flags (success or failure) for all requests of the autonomous vehicle 10 and the estimated fare to the autonomous vehicle 10 (S306).

Thereafter, within a predetermined time (e.g., 5 min), the control system 200 may determine whether a reservation confirmation flag is received from the autonomous vehicle 10 (S307), and when the reservation confirmation flag is not received, reset the reservation progress flag (S308).

When the reservation confirmation flag is received within the predetermined time, the control system 200 may reset the remaining reservation progress flags other than the reservation confirmation request (S309) and transmit the reservation completion flag of the confirmed remote driving reservation to the autonomous vehicle 10 (S310).

Referring to FIG. 6B, the control system 200 may determine whether a remote driving start time has arrived (S311), and when the remote driving start time has arrived, determine whether a control manager starts remote driving control (S312).

When the control manager starts remote driving control, the control system 200 may transmit a remote driving control start signal to the autonomous vehicle 10 (S313).

Then, the control system 200 may check whether the control manager ends the remote driving control (S314), and when the remote driving control is ended, transmit a remote driving end signal to the autonomous vehicle 10 (S315).

As such, according to embodiments of the present disclosure, the control system 200 may receive a remote driving reservation request from the autonomous vehicle 10 and perform the reservation, so as to efficiently perform remote control reservation management. In addition, the control system 200 according to embodiments of the present disclosure check whether remote control is possible at a specific time to plan a path, may ensure that remote control requests are properly distributed to a remote driving control device, and may set a break time for the control manager.

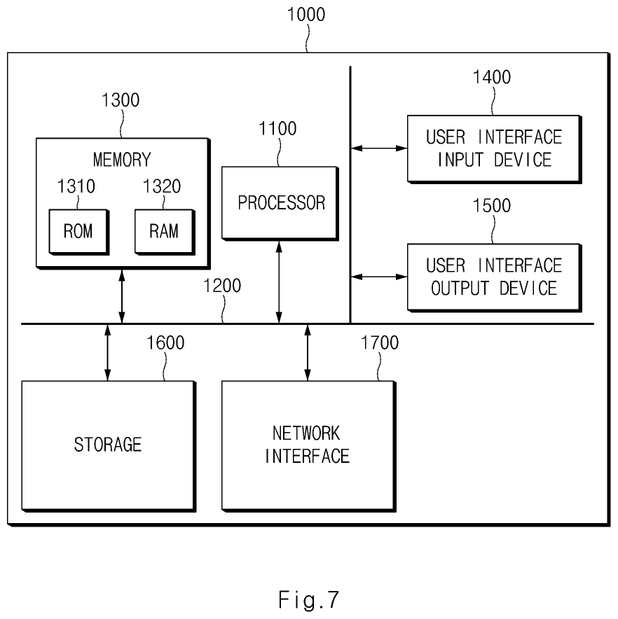

FIG. 7 illustrates a computing system according to an exemplary embodiment of the present disclosure.

Referring to FIG. 7, the computing system 1000 may include at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) 1310 and a random access memory (RAM) 1320.

Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, a EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. An autonomous vehicle comprising:
an autonomous driving control apparatus configured to comprise:
a processor configured to:
generate a candidate path group to a destination,
request a remote driving reservation to a control system when an autonomous driving section and a section requiring remote control are included in the candidate path group,
receive a path selected from the candidate path group by a user, depending on availability of the remote driving reservation and an estimated fare,
control the vehicle to follow the selected path, and
control the vehicle depending on remote control of the control system when the vehicle reaches the section requiring remote control; and
a communication device configured to communicate with the control system.

2. The autonomous driving control apparatus of claim 1, wherein the processor is further configured to generate a final path candidate group in the candidate path group depending on availability of the remote driving reservation and the estimated fare, and
wherein the autonomous driving control apparatus further comprises an interface device configured to display the final path candidate group.

3. The autonomous vehicle of claim 1, wherein the processor is further configured to calculate a fare by applying a predetermined weight to a driving time of the autonomous driving section and a driving time of the section requiring remote control, and
wherein the process is further configured to generate the candidate path group in the order of lowest fare.

4. The autonomous vehicle of claim 1, wherein the processor is further configured to generate the candidate path group in the case of at least one of an initial input of a destination, a change of the destination, or an increase in fare compared to an existing path.

5. The autonomous vehicle of claim 1, wherein the processor is configured to calculate a start time of a section requiring remote control for each candidate path and an end time of a section requiring remote control for each candidate path when generating the candidate path group.

6. The autonomous vehicle of claim 5, wherein the processor is further configured to transmit, to the control system, at least one of a start time of the section requiring remote control for each candidate path, an end time of the section requiring remote control for each candidate path, a path of a section requiring remote control, or vehicle data when requesting the remote driving reservation to the control system.

7. The autonomous vehicle of claim 2, wherein the processor is further configured to generate paths that receive reservation progress flags from the control system as a final path candidate group.

8. The autonomous vehicle of claim 7, wherein the processor is further configured to transmit a reservation confirmation flag of a path selected by a user in the final path candidate group to the control system, and displays the path selected by the user as the final path on the interface device when receiving the reservation completion flag from the control system.

9. The autonomous vehicle of claim 8, wherein the processor is further configured to perform autonomous driving by following the final path, and
wherein the process is further configured to receive a remote driving start signal from the control system and control the vehicle depending on a remote control command received from the control system, when a start point of the remote control required section is reached.

10. The autonomous vehicle of claim 2, wherein the processor is further configured to display a remote driving fare on the interface device, and
wherein the processor is further configured to display a screen indicating that autonomous driving is in progress when driving of the section requiring remote control ends.

11. The autonomous vehicle of claim 2, wherein the processor is further configured to display a screen indicating that a fare is generated on the interface device when re-reserving a path after canceling it during remote driving.

12. A control system comprising:
a processor configured to:
check whether a reservation for a section requiring remote control is available, calculate an estimated fare, and transmit it to an autonomous vehicle when receiving a remote driving reservation request for a path including an autonomous driving section and a section requiring remote control from an autonomous vehicle, and
confirm the reservation to transmit it to the autonomous vehicle when a reservation confirmation for a path selected by a user is requested from the autonomous vehicle depending on the reservation availability and the estimated fare; and
a communication device configured to communicate with the autonomous vehicle.

13. The control system of claim 12, wherein the processor is further configured to check whether the reservation for the section requiring remote control is available based on occupancy of a remote driving control device at a start time of the section requiring remote control and whether driving of the section requiring remote control is possible.

14. The control system of claim 13, wherein the processor is further configured to proceed reservations in order of smallest occupancy on a same day in the remote driving control device.

15. The control system of claim 13, wherein the processor is further configured to transmit a remote driving reservation progress result and an estimated fare for each path requested for remote control to the autonomous vehicle.

16. The control system of claim 15, wherein the processor is further configured to confirm the reservation when a reservation confirmation flag is received from the autonomous vehicle within a predetermined time after the remote driving reservation progress result and the estimated fare are transmitted to the autonomous vehicle.

17. The control system of claim 16, wherein the processor is further configured to initialize all reservation progress flags other than the path for which the reservation is confirmed; and wherein the processor transmits a reservation completion flag for the path for which the reservation is confirmed to the autonomous vehicle.

18. The control system of claim 16, wherein the processor is further configured to start remote control and transmits a remote driving start signal to the autonomous vehicle when the start time of the section requiring remote control is reached.

19. The control system of claim 18, wherein the processor is further configured to determine whether an extension reservation of an allocated remote control device is possible until a recalculated expected remote control end time when the autonomous vehicle does not reach the section requiring remote control within a reserved time; and
wherein the processor is further configured to transmit a reservation cancellation flag to the autonomous vehicle when the extension reservation is impossible.

20. A remote control method for an autonomous vehicle, comprising:
generating a candidate path group to a destination;
requesting a remote driving reservation to a control system when an autonomous driving section and a section requiring remote control are included in the candidate path group;
receiving a path selected from the candidate path group by a user, depending on availability of the remote driving reservation and an estimated fare;
following and controlling the selected path; and
controlling the vehicle depending on remote control of the control system when the vehicle reaches the section requiring remote control.
